(19) United States
(12) Patent Application Publication
(10) Pub. No.: US 2026/0057897 A1
(43) Pub. Date: Feb. 26, 2026

(54) METHOD FOR PROCESSING AUDIO SIGNAL, ELECTRONIC DEVICE, AND COMPUTER-READABLE STORAGE MEDIUM

(71) Applicant: GOERTEK INC., Weifang (CN)

(72) Inventors: Chao JIANG, Weifang (CN); Guoming CHEN, Weifang (CN); Jianhua LI, Weifang (CN); Jingjing LI, Weifang (CN); Jie WU, Weifang (CN)

(21) Appl. No.: 19/374,064

(22) Filed: Oct. 30, 2025

Related U.S. Application Data
(63) Continuation of application No. PCT/CN2024/136599, filed on Dec. 4, 2024.

(30) Foreign Application Priority Data
Apr. 29, 2024 (CN) 202410533458.7

(51) Int. Cl. G10L 21/0232; G10L 21/0208; G10L 21/0216; G10L 25/18; G10L 25/30

(52) U.S. Cl. CPC G10L 21/0232; G10L 25/18; G10L 25/30; G10L 2021/02082; G10L 2021/02163

(57) ABSTRACT

The present application provides a method for processing an audio signal, an electronic device, and a computer-readable storage medium. The present application relates to the technical field of audio processing. The method for processing the audio signal includes: obtaining a current far-end signal and a microphone signal; the microphone signal includes a near-end signal and an echo signal generated by a speaker playing the far-end signal; performing linear echo cancellation processing on the microphone signal to obtain a linear filtered signal; inputting the linear filtered signal and the far-end signal into a pre-trained residual echo cancellation DNN model to output a gain signal corresponding to the near-end signal; and determining a target audio signal to be output to the far-end for playback based on the gain signal and the linear filtered signal.

### CROSS-REFERENCE TO RELATED APPLICATIONS

The present application is a continuation application of International Application No. PCT/CN2024/136599, filed on Dec. 4, 2024, which claims priority to Chinese Patent Application No. 202410533458.7, entitled in “METHOD FOR PROCESSING AUDIO SIGNAL, ELECTRONIC DEVICE, AND COMPUTER-READABLE STORAGE MEDIUM” and filed on Apr. 29, 2024. The disclosures of the above-mentioned applications are incorporated herein by reference in their entireties.

### TECHNICAL FIELD

The present application relates to the technical field of audio processing, and in particular to a method for processing an audio signal, an electronic device, and a computer-readable storage medium.

### BACKGROUND

Echo is caused by coupling between the speaker and microphone, resulting in the signal received by the microphone containing not only the near-end voice signal but also the echo generated by the speaker. If the microphone signal is not processed, the echo signal will be transmitted to the far-end speaker for playback, caconfiguring the far-end caller to hear their own voice delayed, and affecting the call quality.

In related technologies, traditional filters suffer from inaccurate error estimation, resulting in slow convergence and insufficient steady-state performance. Kalman filters offer better steady-state performance but are relatively computationally intensive. Currently, there is no effective way to reduce the computational complexity required for echo cancellation and improve its effectiveness.

### SUMMARY

The main purpose of the present application is to provide a method for processing an audio signal, an electronic device, and a computer-readable storage medium, aiming to improve echo cancellation performance and conserve computing resources required for echo cancellation.

To achieve the above purpose, the present application provides a method for processing an audio signal, including:
obtaining a current far-end signal and a current microphone signal; the microphone signal includes a near-end signal and an echo signal generated by a speaker playing the far-end signal;
performing linear echo cancellation processing on the microphone signal to obtain a linear filtered signal;
inputting the linear filtered signal and the far-end signal into a pre-trained residual echo cancellation deep neural network (DNN) model to output a gain signal corresponding to the near-end signal; and
determining a target audio signal to be output to a far-end for playback based on the gain signal and the linear filtered signal.

In an embodiment, the method for processing the audio signal further includes:
obtaining multiple groups of audio sample data; each group of audio sample data includes a near-end signal sample and a far-end signal sample;
generating a microphone signal sample corresponding to each group of audio sample data based on the near-end signal sample and the far-end signal sample corresponding to each group of audio sample data;
determining a linear filtered signal sample corresponding to each group of audio sample data based on the microphone signal sample corresponding to each group of audio sample data; the linear filtered signal sample is an audio signal sample obtained by performing linear echo cancellation processing on the microphone signal sample; and
determining training samples based on the far-end signal sample, the linear filtered signal sample, and the microphone signal sample corresponding to each group of audio sample data, and training a deep neural network based on the training samples to obtain a trained residual echo cancellation DNN model; each group of audio sample data corresponds to one training sample.

In an embodiment, the generating the microphone signal sample corresponding to each group of audio sample data based on the near-end signal sample and the far-end signal sample corresponding to each group of audio sample data includes:
performing audio equalization reverberation processing and audio delay processing on the far-end signal sample corresponding to each group of audio sample data to obtain an analog echo signal sample corresponding to each group of audio sample data; and
superimposing the analog echo signal sample corresponding to each group of audio sample data with the near-end signal sample corresponding to the same group of audio sample data to obtain the microphone signal sample corresponding to each group of audio sample data.

In an embodiment, the training sample includes a learning sample and a sample label associated with the learning sample;
the determining training samples based on the far-end signal sample, the linear filtered signal sample, and the microphone signal sample corresponding to each group of audio sample data includes:
determining each learning sample of a deep neural network model based on the far-end signal sample and the linear filtered signal sample in each group of audio sample data; and
determining a sample label associated with each learning sample based on the linear filtered signal sample and the near-end signal sample in each group of audio sample data.

In an embodiment, the determining each learning sample of the deep neural network model based on the far-end signal sample and the linear filtered signal sample in each group of audio sample data includes:
performing Fourier transform on the far-end signal sample and linear filtered signal sample in each group of audio sample data to obtain the far-end signal sample and the linear filtered signal sample after Fourier transform;
concatenating the far-end signal sample and the linear filtered signal sample in the same group of audio sample data after Fourier transform to obtain an audio vector sample corresponding to each group of audio sample data; and
configuring the audio vector sample corresponding to each group of audio sample data as each learning sample for the deep neural network model; one audio vector sample corresponds to one learning sample.

In an embodiment, the determining the sample label associated with each learning sample based on the linear filtered signal sample and the near-end signal sample in each group of audio sample data includes:
performing Fourier transform on the linear filtered signal sample and the near-end signal sample in each group of audio sample data to obtain the linear filtered signal sample and the near-end signal sample after Fourier transform;
dividing the linear filtered signal sample and the near-end signal sample in the same group of audio sample data after Fourier transform to obtain a gain signal sample corresponding to each group of audio sample data; and
configuring the gain signal sample corresponding to each group of audio sample data as the sample label associated with each learning sample; one gain signal sample corresponds to one sample label, and one learning sample is associated with one sample label; the sample label associated with the learning sample is the gain signal sample corresponding to the same group of audio sample data.

In an embodiment, the determining the target audio signal to be output to the far-end based on the gain signal and the linear filtered signal includes:
multiplying the gain signal and the linear filtered signal to obtain a product audio vector; and
configuring the product audio vector as the target audio signal to be output to the far-end for playback.

In an embodiment, the obtaining the current far-end signal and the current microphone signal includes:
dynamically collecting a far-end audio time domain signal and a microphone audio time domain signal generated during a call; the microphone signal includes a near-end audio time domain signal and an echo audio time domain signal generated by a speaker playing the far-end audio time domain signal;
performing Fourier transform on the far-end audio time domain signal and the microphone audio time domain signal, respectively, to obtain a far-end audio frequency domain signal and a microphone audio frequency domain signal; and configuring the far-end audio frequency domain signal as the current far-end signal,
and configuring the microphone audio frequency domain signal as the current microphone signal.

The present application also provides an electronic device, including:
at least one processor; and
a memory communicatively connected to the at least one processor;
the memory stores instructions executable by the at least one processor, and the instructions are executed by the at least one processor to enable the at least one processor to implement the steps of the method for processing the audio signal.

The present application also provides a computer-readable storage medium; the computer-readable storage medium stores a program for implementing a method for processing an audio signal, and the program is executed by a processor to implement the steps of the method for processing the audio signal.

The present application also provides a computer program product, including a computer program; the computer program, when executed by a processor, implements the steps of the above-mentioned method for processing the audio signal.

The technical solution of the present application is to obtain a current far-end signal and a current microphone signal; the microphone signal includes a near-end signal and an echo signal generated by a speaker playing the far-end signal.

Then, linear echo cancellation processing is performed on the microphone signal to obtain a linear filtered signal. The linear filtered signal and the far-end signal are then input into a pre-trained residual echo cancellation DNN model, which outputs a gain signal corresponding to the near-end signal. Based on this gain signal and the linear filtered signal, a target audio signal to be output to the far-end for playback is determined. This results in a hybrid echo cancellation module, which combines an acoustic echo canceller (AEC) module based on a linear filter and a residual echo cancellation (RES) module based on a DNN neural network. Compared to traditional RES algorithms, due to the more powerful nonlinear processing capabilities of deep neural networks, the technical solution of the present application can achieve better echo cancellation results and save computing resources required for echo cancellation.

It is worth mentioning that the solution of filtering through Kalman filter in the related art requires more configuration parameters. Compared with this solution, the embodiment of the present application saves the amount of calculation and can achieve the effect of improving the accuracy of echo cancellation. The present application forms a cascade with the AEC adaptive filter and the deep learning model, which can not only eliminate linear echo signals, but also eliminate nonlinear echo signals, thereby obtaining a better listening experience during voice transmission and improving the user experience. In addition, the present application achieves better echo suppression effect by replacing the traditional RES module with the DNN neural network RES, which is better at handling nonlinear problems.

### BRIEF DESCRIPTION OF THE DRAWINGS

The drawings herein are incorporated into the specification and constitute a part of the specification, showing embodiments that conform to the present application, and together with the specification, are used to explain the principles of the present application.

In order to more clearly illustrate the technical solutions in the embodiments of the present application or the related art, the drawings required for use in the embodiments or the related art description will be briefly introduced below. Obviously, for those skilled in the art, other drawings can be obtained based on these drawings without creative labor.

FIG. 1 is a flowchart of a method for processing an audio signal according to a first embodiment of the present application.

FIG. 2 is a flowchart of the method for processing the audio signal according to a second embodiment of the present application.

FIG. 3 is a block diagram of a process for generating model training data according to an embodiment of the present application.

FIG. 4 is a schematic diagram of a model structure of a residual echo cancellation DNN model according to an embodiment of the present application.

FIG. 5 is a block diagram of a process for the method for processing the audio signal according to an embodiment of the present application.

FIG. 6 is a schematic diagram of a module structure of a device for processing an audio signal according to an embodiment of the present application.

FIG. 7 is a schematic diagram of a structure of the electronic device according to an embodiment of the present application.

The purpose, functional features and advantages of the present application will be further explained in conjunction with the embodiments and with reference to the accompanying drawings.

### DETAILED DESCRIPTION OF THE EMBODIMENTS

It should be understood that the specific embodiments described herein are only used to explain the technical solution of the present application and are not used to limit the present application.

In order to better understand the technical solution of the present application, the following will be described in detail in conjunction with the drawings of the specification and the specific implementation methods.

The main solution of the present application is as follows: obtaining a current far-end signal and a microphone signal; the microphone signal includes a near-end signal and an echo signal generated by a speaker playing the far-end signal; performing linear echo cancellation processing on the microphone signal to obtain a linear filtered signal; inputting the linear filtered signal and the far-end signal into a pre-trained residual echo cancellation DNN model to output a gain signal corresponding to the near-end signal; and determining a target audio signal to be output to the far-end based on the gain signal and the linear filtered signal.

In related art, traditional filter error estimation is inaccurate, resulting in slow convergence and insufficient steady-state performance. Kalman filters have better steady-state performance but are relatively computationally intensive. Currently, there is no effective method in related art to reduce the computational complexity required for echo cancellation and improve echo cancellation performance.

The technical solution of the present application is to obtain a current far-end signal and a microphone signal; the microphone signal includes a near-end signal and an echo signal generated by a speaker playing the far-end signal. Then, linear echo cancellation processing is performed on the microphone signal to obtain a linear filtered signal. The linear filtered signal and the far-end signal are then input into a pre-trained residual echo cancellation deep neural network (DNN) model, which outputs a gain signal corresponding to the near-end signal. Based on this gain signal and the linear filtered signal, a target audio signal to be output to the far-end is determined. This results in a hybrid echo cancellation module, which combines an acoustic echo canceller (AEC) module based on a linear filter and a residual echo cancellation (RES) module based on a DNN neural network. Compared to traditional RES algorithms, due to the more powerful nonlinear processing capabilities of deep neural networks, the technical solution of the present application can achieve better echo cancellation results and save computing resources required for echo cancellation.

It's worth noting that the Kalman filter filtering scheme used in related art requires a large number of configuration parameters. Compared to this scheme, the embodiments of the present application reduce computational complexity while also improving echo cancellation accuracy. By cascading an AEC adaptive filter with a deep learning model, the present application not only eliminates linear echo signals but also nonlinear echo signals, thereby achieving a better listening experience and enhancing the user experience during voice transmission. Furthermore, the present application replaces the traditional RES module with a DNN neural network RES, which is more effective at handling nonlinear problems, to achieve even better echo suppression.

It should be noted that the implementation of this embodiment can be an electronic device with call functionality, such as a headset, mobile phone, smartwatch, personal digital assistant (PDA), augmented reality (AR)/virtual reality (VR) device, or a computing service device with data processing, network communication, and program execution capabilities, such as a tablet computer or personal computer, or an device for processing an audio signal for a call that can perform the above functions. This embodiment is not specifically limited to these. Before further explaining the embodiments of the present application, the terms and definitions used in these embodiments are explained. The following interpretations apply to these terms and definitions.
1) Near-end and far-end: in bidirectional communication, near-end and far-end are relative terms. For example, if user A and user B are communicating via terminal devices, and user B's terminal device is considered the near-end, then user A's terminal device corresponds to the far-end. Conversely, if user B's terminal device is considered the far-end, then user A's terminal device corresponds to the near-end. In these embodiments, the side of the terminal device that executes the communication is considered the near-end.
2) Near-end signal and far-end signal: the near-end signal refers to the near-end audio signal, while the far-end signal refers to the far-end audio signal.
3) Linear echo (direct echo): the echo generated when the near-end microphone directly captures the voice signal played by the near-end speaker. Direct echo is not affected by the surrounding environment and is significantly affected by the distance and position between the speaker and the microphone. Therefore, direct echo is a linear signal.
4) Nonlinear echo (indirect echo): after the near-end speaker broadcasts the voice signal, it reflects off the complex and variable wall surfaces before being picked up by the near-end microphone. The magnitude of the indirect echo depends on factors such as the room environment, object placement, and the wall's attraction coefficient. Therefore, indirect echo is a nonlinear signal.
5) linear echo cancellation processing is a type of echo cancellation technology primarily used to address direct echo (also known as linear echo). Direct echo refers to the echo generated by the near-end microphone directly picking up the voice signal after the near-end speaker broadcasts it. This echo is unaffected by the environment and is significantly affected by the distance and position between the speaker and the microphone. Therefore, it is a linear signal. A common method for linear echo cancellation processing is to use echo path cancellation technology. Specifically, when the audio conferencing system in room A receives audio from room B, the audio is sampled. This sample is called the echo cancellation reference. The audio is then sent to the speakers and acoustic echo canceller in room A. When the sound from room B is picked up by the microphone in room A along with the sound from room A, the sound is sent to an acoustic echo canceller, where it is compared with the original sample and the sound from room B is removed. Adaptive filters are also a key tool in linear echo cancellation processing. Based on an estimate of the statistical characteristics of the input and output signals, adaptive filters employ specific algorithms to automatically adjust the filter coefficients to achieve optimal filtering characteristics. Such filters can be continuous-domain or discrete-domain. Discrete-domain adaptive filters consist of a set of tapped delay lines, variable weighting coefficients, and a mechanism for automatically adjusting the coefficients.
6) Fourier transform. The Fourier transform possesses numerous properties, including linearity, translation, scaling, residue theorem, convolution theorem, periodicity, and symmetry. These properties make the Fourier transform widely used in fields such as signal processing and image analysis. For example, in communication systems, the Fourier transform is used for frequency domain signal transmission and detection, enabling channel transmission. In audio and image processing, the Fourier transform can convert time domain signals into frequency domain signals for frequency analysis and filtering, enabling operations such as noise reduction, compression, and enhancement.

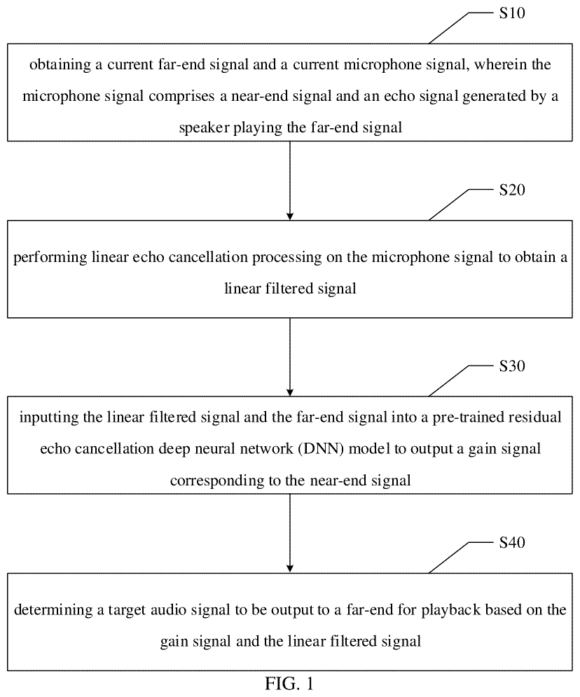

The following describes the method for processing the audio signal according to an exemplary embodiment of the present application with reference to FIG. 1.

Based on this, the present application provides a first embodiment of the method for processing the audio signal. Referring to FIG. 1, the method for processing the audio signal includes steps S10 to S40:

Step S10: acquiring a current far-end signal and microphone signal; the microphone signal includes a near-end signal and an echo signal generated by a speaker playing back the far-end signal.

Those skilled in the art will appreciate that near-end and far-end are relative terms. Near-end refers to the relatively close location of a signal transmitting or receiving device. Far-end refers to the relatively far location of a signal transmitting or receiving device. For example, when communicating with the outside world in a confined space, the signal from the other party is called the far-end signal, while the signal you express to the other party is called the near-end signal. The far-end signal is converted into an audio signal by the speaker. After multiple reflections in the confined space, it is received by the microphone and superimposed with the near-end signal, which is then transmitted to the other party. This superposition may cause the other party to hear their own voice in addition to the voice of the near-end signal, i.e., an echo.

### Exemplarily, Step S10 May Include:

Step S11, dynamically collecting a far-end audio time domain signal and a microphone audio time domain signal generated during a call; the microphone signal includes a near-end audio time domain signal and an echo audio time domain signal generated by a speaker playing back the far-end audio time domain signal;
Step S12, performing Fourier transforms on the far-end audio time domain signal and the microphone audio time domain signal to obtain a far-end audio frequency domain signal and a microphone audio frequency domain signal;
Step S13, configuring the far-end audio frequency domain signal as the current far-end signal and the microphone audio frequency domain signal as the current microphone signal.

This embodiment effectively obtains the aforementioned far-end signal and microphone signal by dynamically collecting the far-end audio time domain signal and the microphone audio time domain signal generated during a call, and performing Fourier transforms on the far-end audio time domain signal and the microphone audio time domain signal to obtain a far-end audio frequency domain signal and a microphone audio frequency domain signal. Furthermore, the far-end audio time-domain signal and the microphone audio time-domain signal are Fourier transformed to obtain a far-end audio frequency-domain signal and a microphone audio frequency-domain signal, respectively. This conversion from time-domain signals to frequency-domain signals significantly reduces the complexity of the residual echo cancellation deep neural network (DNN) model described later, thereby further conserving computing resources required for echo cancellation.

The far-end audio frequency-domain signal is the audio frequency-domain signal received by the far-end device in the aforementioned embodiment, and the microphone signal includes the near-end audio time-domain signal and the echo audio time-domain signal resulting from the playback of the far-end audio time-domain signal.

After step S10, step S20 is executed to perform linear echo cancellation processing on the microphone signal to obtain a linear filtered signal.

In linear filtering, the input signal may include the far-end signal and the microphone signal. When linearly filtering the microphone signal based on the far-end signal, the delay difference between the far-end signal and the microphone signal due to delay jitter can also be estimated. This delay difference can then be used to linearly filter the microphone signal, which can improve the accuracy of linear filtering and reduce the degree of speech distortion in the resulting linear filtered signal.

Step S30: inputting the linear filtered signal and the far-end signal into a pre-trained residual echo cancellation DNN model, which outputs a gain signal corresponding to the near-end signal.

In nonlinear filtering, the input signal includes the linear filtered signal and the far-end signal. Because the delay difference between the original far-end signal and the microphone signal is estimated, a small delay difference may still exist between the linear filtered signal and the far-end signal. Furthermore, the far-end signal is captured by the near-end microphone after complex and variable wall reflections. This means that the linear filtered signal also includes indirect echo signal components. Indirect echo is a nonlinear signal that cannot be eliminated by linear echo cancellation processing. Therefore, this embodiment inputs the linear filtered signal and the far-end signal into a pre-trained residual echo cancellation DNN model, outputting a gain signal corresponding to the near-end signal. This gain signal serves as a reference signal for nonlinear filtering of the linear filtered signal. This facilitates subsequent determination of the target audio signal to be output to the far-end based on the gain signal and the linear filtered signal, thereby improving the accuracy of nonlinear filtering.

The residual echo cancellation DNN model may include a filter function, including but not limited to a least mean square (LMS) filter and a multi-delay block frequency domain adaptive filter (MDF) function.

This embodiment uses both the linear filtered signal and the far-end signal as input signals for training the residual echo cancellation DNN model. This model can fully utilize relevant information to extract the residual nonlinear echo from the linear filtered signal and, based on this residual nonlinear echo, determine a reference parameter signal; i.e., the gain signal corresponding to the near-end signal, used to characterize the nonlinear filtering of the linear filtered signal. For example, a vector operation is performed on the gain signal and the linear filtered signal, and the result obtained is the target audio signal output to the remote end for playback. The vector operation includes at least one of addition, subtraction, multiplication, and division. This embodiment does not specifically limit this.

After step S30, step S40 is executed to determine the target audio signal to be output to the far-end for playback based on the gain signal and the linear filtered signal.

Exemplarily, step S40, the determining the target audio signal to be output to the far-end for playback based on the gain signal and the linear filtered signal, includes:
Step S41, multiplying the gain signal and the linear filtered signal to obtain a product audio vector;
Step S42, configuring the product audio vector as the target audio signal to be output to the far-end for playback.

This embodiment, by multiplying the gain signal and the linear filtered signal to obtain a product audio vector and configuring the product audio vector as the target audio signal to be output to the far-end for playback, can achieve a more robust target audio signal despite the influence of indirect echo or delay estimation errors. The gain signal is a reference parameter signal that characterizes the nonlinear filtering performed on the linear filtered signal.

In this embodiment, two echo cancellation processes are performed in two parts. In the first part, the echo is initially cancelled (i.e., linear echo cancellation processing). Then, in the second part, residual echo cancellation (i.e., nonlinear echo cancellation processing) is performed on the signal after the initial cancellation. This allows for more robust results under the influence of indirect echoes or delay estimation errors.

The technical solution of the embodiments of the present application is to obtain a current far-end signal and a microphone signal; the microphone signal includes a near-end signal and an echo signal generated by a speaker playing the far-end signal. The microphone signal is then subjected to linear echo cancellation processing to obtain a linear filtered signal. The linear filtered signal and the far-end signal are then input into a pre-trained residual echo cancellation DNN model, which outputs a gain signal corresponding to the near-end signal. Based on the gain signal and the linear filtered signal, a target audio signal to be output to the far-end is determined. This provides a hybrid echo cancellation module, which combines an acoustic echo canceller (AEC) module based on a linear filter and a residual echo cancellation (RES) module based on a DNN neural network. Compared to traditional RES algorithms, the technical solution of the present application can achieve better echo cancellation performance and save computing resources required for echo cancellation, due to the more powerful nonlinear processing capabilities of deep neural networks.

It's worth noting that the Kalman filter filtering scheme used in related art requires a large number of configuration parameters. Compared to this scheme, the present embodiment reduces computational complexity while also improving echo cancellation accuracy. By cascading an AEC adaptive filter with a deep learning model, the present embodiment can eliminate not only linear but also nonlinear echo signals, thereby achieving a better listening experience and enhancing the user experience during voice transmission. Furthermore, the present embodiment replaces the traditional RES module with a DNN neural network RES, which is more effective at handling nonlinearities, to achieve even better echo suppression.

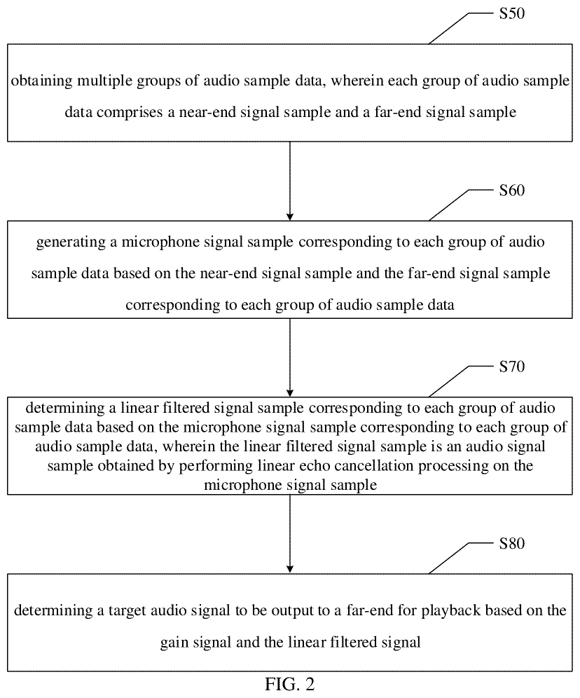

In one possible implementation, please refer to FIG. 2, which is a flowchart of the method for processing the audio signal according to the second embodiment of the present application. The method further includes:

Step S50: acquiring multiple groups of audio sample data, each group of audio sample data including a near-end signal sample and a far-end signal sample.

In this embodiment, each group of audio sample data is different. That is, each group of audio sample data contains different near-end signal samples and different far-end signal samples.

Step S60, generating microphone signal samples corresponding to each group of audio sample data based on the near-end signal samples and far-end signal samples corresponding to each group of audio sample data.

Exemplarily, step S60, the generating microphone signal samples corresponding to each group of audio sample data based on the near-end signal samples and far-end signal samples corresponding to each group of audio sample data, specifically including:
Step S61, performing audio equalization, reverberation, and audio delay processing on the far-end signal samples corresponding to each group of audio sample data to obtain simulated echo signal samples corresponding to each group of audio sample data;
Step S62, superimposing the simulated echo signal samples corresponding to each group of audio sample data with the near-end signal samples corresponding to the same group of audio sample data to obtain microphone signal samples corresponding to each group of audio sample data.

This embodiment simulates the effect of echo generation through audio equalization, reverberation, and audio delay processing to obtain simulated echo signal samples corresponding to each group of audio sample data. The reverberation frequency modulation parameters for the audio equalization and reverberation processing, as well as the delay parameters for the audio delay, can be set by those skilled in the art according to actual circumstances and are not specifically limited in this embodiment. The purpose is to more accurately and realistically simulate the echo generation effect.

This embodiment performs audio equalization and reverberation processing and audio delay processing on the far-end signal samples corresponding to each group of audio sample data to obtain simulated echo signal samples corresponding to each group of audio sample data. The simulated echo signal samples corresponding to each group of audio sample data are then superimposed with the near-end signal samples corresponding to the same group of audio sample data, thereby efficiently and accurately obtaining microphone signal samples corresponding to each group of audio sample data.

After step S60, step S70 is executed to determine, based on the microphone signal samples corresponding to each group of audio sample data, the linear filtered signal samples corresponding to each group of audio sample data. The linear filtered signal samples are audio signal samples obtained by performing linear echo cancellation processing on the microphone signal samples.

In step S80, determining training samples based on the far-end signal samples, linear filtered signal samples, and microphone signal samples corresponding to each group of audio samples. A deep neural network is trained based on each training sample to obtain a trained residual echo cancellation DNN model. Each group of audio sample data corresponds to one training sample.

In this embodiment, the far-end signal samples are used to generate simulated far-end echo signal samples (i.e., simulated echo signal samples), and the simulated echo signal samples and near-end signal samples are used to generate simulated near-end microphone signal samples. Here, training samples are determined based on the far-end signal samples, linear filtered signal samples, and microphone signal samples corresponding to each group of audio samples. configuring such training sample data, a large number of far-end echoes and corresponding near-end microphone signals can be conveniently constructed, thereby effectively training the residual echo cancellation DNN model.

This embodiment obtains multiple groups of audio sample data, each group of audio sample data including a near-end signal sample and a far-end signal sample. Based on the near-end signal samples and far-end signal samples corresponding to each group of audio sample data, microphone signal samples corresponding to each group of audio sample data are generated. Then, based on the microphone signal samples corresponding to each group of audio sample data, linear filtered signal samples corresponding to each group of audio sample data are determined. The linear filtered signal samples are audio signal samples obtained by performing linear echo cancellation processing on the microphone signal samples. Training samples are determined based on the far-end signal samples, linear filtered signal samples, and microphone signal samples corresponding to each group of audio sample data. A deep neural network is trained based on each training sample to obtain a trained residual echo cancellation DNN model. Each group of audio sample data corresponds to one training sample, thereby achieving a lightweight residual echo cancellation DNN model structure that exhibits the features of accurate processing, real-time performance, and low computational resource consumption.

Based on the first embodiment of the present application, in the second embodiment of the present application, the same or similar contents as those of the first embodiment above can be referred to above and will not be further elaborated. On this basis, the training samples include learning samples and sample labels associated with the learning samples. The step of determining each training sample based on the far-end signal samples, linear filtered signal samples, and microphone signal samples corresponding to each group of audio samples includes:
Step A10: determining each learning sample for the deep neural network model based on the far-end signal samples and linear filtered signal samples in each group of audio sample data;
Step A20: determining a sample label associated with each learning sample based on the linear filtered signal samples and near-end signal samples in each group of audio sample data.

As a feasible implementation, the far-end signal samples and linear filtered signal samples in each group of audio sample data can be directly used as the learning samples for the deep neural network model.

Correspondingly, as a feasible implementation, the linear filtered signal samples and near-end signal samples in each group of audio sample data can be directly used as the sample labels associated with each learning sample.

This embodiment determines learning samples for a deep neural network model based on the far-end signal samples and linear filtered signal samples in each group of audio sample data, and determines sample labels associated with each learning sample based on the linear filtered signal samples and near-end signal samples in each group of audio sample data, thereby effectively obtaining training samples for training the residual echo cancellation DNN model.

As another feasible implementation, step A10, determining learning samples for the deep neural network model based on the far-end signal samples and linear filtered signal samples in each group of audio sample data, includes:
Step A11, performing Fourier transform on the far-end signal samples and linear filtered signal samples in each group of audio sample data to obtain Fourier transformed far-end signal samples and linear filtered signal samples;
Step A12, concatenating the Fourier transformed far-end signal samples and linear filtered signal samples in the same group of audio sample data to obtain audio vector samples corresponding to each group of audio sample data;
Step A13, configuring the audio vector samples corresponding to each group of audio sample data as learning samples for the deep neural network model; one audio vector sample corresponds to one learning sample.

This embodiment performs Fourier transforms on the far-end signal samples and linear filtered signal samples in each group of audio sample data to obtain Fourier transformed far-end signal samples and linear filtered signal samples. The Fourier transformed far-end signal samples and linear filtered signal samples in the same group of audio sample data are then concatenated to obtain audio vector samples corresponding to each group of audio sample data. The audio vector samples corresponding to each group of audio sample data are used as learning samples for a deep neural network model. One audio vector sample corresponds to one learning sample. This further reduces the training complexity of the residual echo cancellation DNN model, improves model convergence efficiency and accuracy, and enables training to obtain a more lightweight residual echo cancellation DNN model structure. This ensures that the resulting residual echo cancellation DNN model has the characteristics of accurate processing, real-time performance, and low computational resource consumption.

Correspondingly, as another feasible implementation, step A20, determining a sample label associated with each learning sample based on the linear filtered signal samples and near-end signal samples in each group of audio sample data, includes:
Step A21, performing Fourier transform on the linear filtered signal samples and near-end signal samples in each group of audio sample data to obtain the Fourier transformed linear filtered signal samples and near-end signal samples;
Step A22, dividing the Fourier transformed linear filtered signal samples and near-end signal samples in the same group of audio sample data to obtain a gain signal sample corresponding to each group of audio sample data;
Step A23, configuring the gain signal sample corresponding to each group of audio sample data as the sample label associated with each learning sample; one gain signal sample corresponds to one sample label, and one learning sample is associated with one sample label; the sample label associated with the learning sample is the gain signal sample corresponding to the same group of audio sample data.

This embodiment performs Fourier transforms on the linear filtered signal samples and near-end signal samples in each group of audio sample data to obtain the Fourier transformed linear filtered signal samples and near-end signal samples. Then, the Fourier transformed linear filtered signal samples and near-end signal samples in the same group of audio sample data are divided to obtain the gain signal samples corresponding to each group of audio sample data. The gain signal samples corresponding to each group of audio sample data are used as sample labels associated with each learning sample. Each gain signal sample corresponds to a sample label, and each learning sample is associated with a sample label. The sample labels associated with learning samples are the gain signal samples corresponding to the same group of audio sample data. This can further reduce the training complexity of the residual echo cancellation DNN model, improve the model convergence efficiency and accuracy, and train a more lightweight residual echo cancellation DNN model structure. This enables the obtained residual echo cancellation DNN model to achieve good nonlinear residual echo cancellation performance while reducing the computational complexity of the entire algorithm. This results in a better listening experience and an enhanced user experience during voice transmission.

To help understand the technical concepts and principles of the method for processing the audio signal of the present application, a specific embodiment is listed below:

This embodiment primarily provides a hybrid echo cancellation module that combines an AEC module based on a linear filter and a RES module based on a DNN neural network. Compared to traditional RES algorithms, neural networks have more powerful nonlinear processing capabilities. This method can achieve better echo cancellation results. The main steps are as follows:

### I. Data Preparation

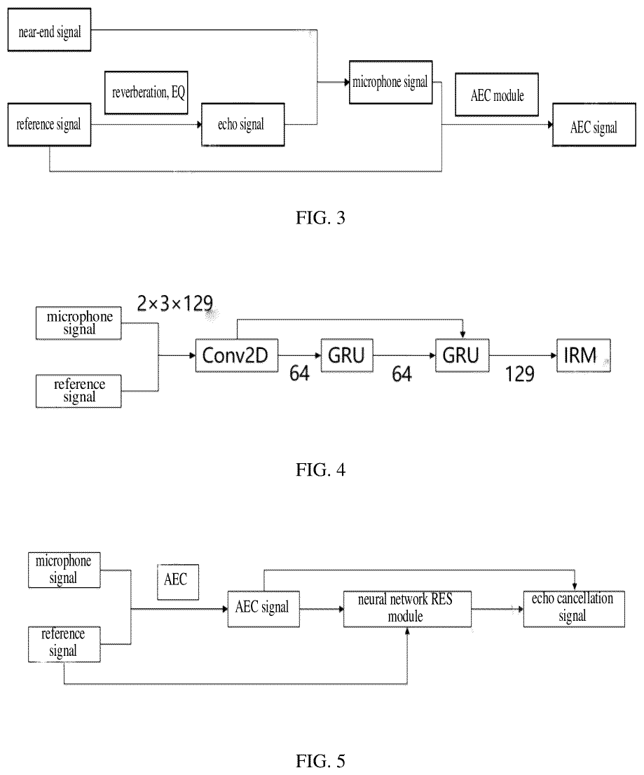

Referring to FIG. 3, FIG. 3 is a flowchart of the model training data generation process in a specific embodiment of the present application. The specific method is as follows:
1. Randomly selecting two recordings and trimming them to make them of the same length.
2. Selecting one as the reference signal (i.e., the far-end signal sample mentioned above) and the other as the near-end signal sample.
3. To simulate the reflections and nonlinear distortion of real-world scenarios, subjecting the reference signal to reverberation and random EQ (equalizer) processing; the resulting data is considered to be a real-world echo signal (i.e., the echo signal samples described above).
4. Adding the near-end signal samples and the echo signal samples together to simulate a real-world microphone signal (i.e., the microphone signal samples described above).
5. Inputting the microphone signal and the reference signal into an AEC module based on a traditional algorithm, to obtain a processed signal, denoted as the AEC signal (i.e., the linear filtered signal samples described above).
6. Repeating steps 1 to 5 to obtain a large number of AEC signals, corresponding reference signals, and near-end signal samples, which serve as training samples for the residual echo cancellation DNN model.

### II. Model Training

Please refer to FIG. 4, FIG. 4 provides a schematic diagram of the model structure of the residual echo cancellation DNN model in a specific embodiment of the present application. In this embodiment, a neural network with two input channels and one output channel is designed as the DNN-based RES module. The gate recurrent unit (GRU) in FIG. 4 is a type of recurrent neural network. Like the long-short term memory (LSTM), it was developed to address issues such as long-term memory and gradients in backpropagation. Specifically, the process involves:
1. Calculating the input to the neural network (i.e., the residual echo cancellation DNN model). This involves Fourier transform the reference signal and AEC signal obtained through the above process (with a frame length of 256 points), grouping three consecutive frames together.
2. Calculating the output of the neural network. Fourier transform the AEC and near-end signal samples obtained through the above process (with a frame length of 256 points) is performed. The near-end signal, transformed configuring the Fast Fourier Transform (FFT), is divided by the corresponding AEC signal to obtain the ideal gain value for each frame, denoted as invariant risk minimization (IRM).
3. Training. First, concatenating (stacking) the microphone signal and the corresponding AEC signal to obtain a 2×3×129 data set, which serves as the neural network input. The IRM corresponding to the AEC signal in the middle frame is used as the output to train the neural network RES module.

### III. Network Model Usage

Please refer to FIG. 5, FIG. 5 provides a flowchart of the method for processing the audio signal in a specific embodiment of the present application.

In this embodiment, because the RES module also uses the FFT-transformed AEC signal and the reference signal as input, the traditional RES module can be replaced with a trained neural network RES module. The output (the output is the gain signal corresponding to the near-end signal) is then multiplied by the AEC signal (here, the AEC signal is a linear filtered signal) to obtain the RES result (the RES result is the target audio signal).

The residual echo suppression (RES) in this embodiment primarily reduces echo through nonlinear processing. Since traditional algorithms are generally ineffective for nonlinear processing, this embodiment considers replacing the traditional RES module with a DNN neural network RES, which is more effective in handling nonlinear issues, to achieve better audio signal processing results.

It should be noted that the above examples are intended only to facilitate understanding of the present application and do not constitute a limitation of the method for processing the audio signal of the present application. Simple transformations based on this technical concept in various other forms are within the protection scope of the present application.

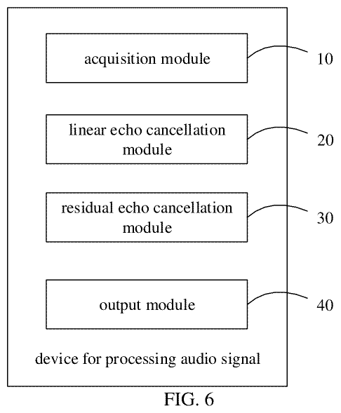

This embodiment of the present application also provides a device for processing an audio signal. Please refer to FIG. 6, FIG. 6 is a schematic diagram of the module structure of the device for processing the audio signal according to this embodiment of the present application. The device for processing the audio signal includes:

An acquisition module 10, configured for acquiring a current far-end signal and a microphone signal; the microphone signal includes a near-end signal and an echo signal generated by a speaker playing the far-end signal;

A linear echo cancellation module 20, configured for performing linear echo cancellation processing on the microphone signal to obtain a linear filtered signal;

A residual echo cancellation module 30, configured for inputting the linear filtered signal and the far-end signal into a pre-trained residual echo cancellation DNN model to output a gain signal corresponding to the near-end signal;

An output module 40, configured for determining a target audio signal to be output to the far-end based on the gain signal and the linear filtered signal.

In an embodiment, the device for processing the audio signal further includes a training module (not shown), configured to:
acquire multiple groups of audio sample data, each group of audio sample data including a near-end signal sample and a far-end signal sample;
generate microphone signal samples corresponding to each group of audio sample data based on the near-end signal samples and far-end signal samples corresponding to each group of audio sample data;
determine linear filtered signal samples corresponding to each group of audio sample data based on the microphone signal samples corresponding to each group of audio sample data;
the linear filtered signal samples are audio signal samples obtained by performing linear echo cancellation processing on the microphone signal samples;
determine individual training samples based on the far-end signal samples, linear filtered signal samples, and microphone signal samples corresponding to each group of audio sample data, and train a deep neural network based on the training samples to obtain a trained residual echo cancellation DNN model; each group of audio sample data corresponds to one training sample.

### In an Embodiment, the Training Module is Further Configured to:

perform audio equalization, reverberation, and audio delay processing on the far-end signal samples corresponding to each group of audio sample data to obtain analog echo signal samples corresponding to each group of audio sample data;
superimpose the analog echo signal samples corresponding to each group of audio sample data with the near-end signal samples corresponding to the same group of audio sample data to obtain microphone signal samples corresponding to each group of audio sample data.

In an embodiment, the training samples include learning samples and sample labels associated with the learning samples. The training module is further configured to:
determine individual learning samples for the deep neural network model based on the far-end signal samples and linear filtered signal samples in each group of audio sample data;
determine sample labels associated with each learning sample based on the linear filtered signal samples and near-end signal samples in each group of audio sample data.

In an embodiment, the training module is further configured to:
perform Fourier transforms on the far-end signal samples and linear filtered signal samples in each group of audio sample data to obtain Fourier transformed far-end signal samples and linear filtered signal samples;
concatenate the Fourier transformed far-end signal samples and linear filtered signal samples in the same group of audio sample data to obtain audio vector samples corresponding to each group of audio sample data;
use the audio vector samples corresponding to each group of audio sample data as learning samples for the deep neural network model; one audio vector sample corresponds to one learning sample.

### In an Embodiment, the Training Module is Further Configured to:

perform Fourier transforms on the linear filtered signal samples and near-end signal samples in each group of audio sample data to obtain linear filtered signal samples and near-end signal samples after Fourier transforms;
divide the linear filtered signal samples and near-end signal samples after Fourier transforms in the same group of audio sample data to obtain gain signal samples corresponding to each group of audio sample data;
use the gain signal samples corresponding to each group of audio sample data as sample labels associated with each learning sample; one gain signal sample corresponds to one sample label, and one learning sample is associated with one sample label; the sample label associated with the learning sample is the gain signal sample corresponding to the same group of audio sample data.

### In an Embodiment, the Output Module 40 is Further Configured to:

multiply the gain signal and the linear filtered signal to obtain a product audio vector;
use the product audio vector as the target audio signal to be output to the far-end for playback.

### In an Embodiment, the Acquisition Module 10 is Further Configured to:

dynamically collect a far-end audio time domain signal and a microphone audio time domain signal generated during a call; the microphone signal includes a near-end audio time domain signal and an echo audio time domain signal generated by a speaker playing back the far-end audio time domain signal;
perform Fourier transforms on the far-end audio time domain signal and the microphone audio time domain signal, respectively, to obtain a far-end audio frequency domain signal and a microphone audio frequency domain signal;
use the far-end audio frequency domain signal as the current far-end signal and the microphone audio frequency domain signal as the current microphone signal.

The device for processing the audio signal provided in the embodiments of the present application utilizes the method for processing the audio signal of the above-described embodiments, thereby improving echo cancellation performance and reducing the computing resources required for echo cancellation. Compared to the related art, the device for processing the audio signal provided in the embodiments of the present application achieves the same beneficial effects as the method for processing the audio signal provided in the above-described embodiments. Other technical features of the device for processing the audio signal are the same as those disclosed in the above-described embodiments and are not further described here.

The present application provides an electronic device, including: at least one processor; and a memory communicatively connected to the at least one processor; the memory stores instructions executable by the at least one processor, and the instructions are executed by the at least one processor to enable the at least one processor to perform the method for processing the audio signal of the above-described embodiments.

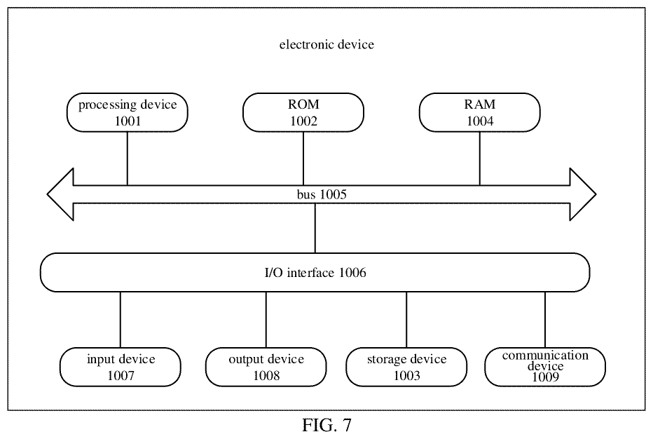

Referring below to FIG. 7, a schematic diagram of a structure of an electronic device suitable for implementing the embodiments of the present application is shown. The electronic devices in the embodiments of the present application may include, but are not limited to, mobile terminals such as mobile phones, laptop computers, digital broadcast receivers, personal digital assistant (PDA), portable application description (PAD), portable media player (PMP), and in-vehicle terminals (e.g., in-vehicle navigation terminals), as well as fixed terminals such as digital TVs and desktop computers. The electronic device shown in FIG. 7 is merely an example and should not limit the functionality or scope of use of the embodiments of the present application.

As shown in FIG. 7, the electronic device may include a processing device 1001 (e.g., a central processing unit, a graphics processing unit, etc.), which can perform various appropriate actions and processes based on programs stored in a read-only memory (ROM) 1002 or programs loaded from a storage device 1003 into a random access memory (RAM) 1004. RAM 1004 also stores various programs and data required for the operation of the electronic device. Processing device 1001, ROM 1002, and RAM 1004 are interconnected via a bus 1005. An input/output 30) (I/O) interface 1006 is also connected to the bus. Typically, the following systems may be connected to the I/O interface 1006: input devices 1007 including, for example, a touchscreen, touchpad, keyboard, mouse, image sensor, microphone, accelerometer, gyroscope, etc.; output devices 1008 including, for example, a liquid crystal display (LCD), speaker, vibrator, etc.; storage devices 1003 including, for example, a magnetic tape, hard disk, etc.; and communication devices 1009. Communication devices 1009 may allow the electronic device to communicate with other devices wirelessly or wired to exchange data. Although the figure shows an electronic device with various systems, it should be understood that not all of the illustrated systems are required to be implemented or present. More or fewer systems may alternatively be implemented or present.

In particular, according to embodiments disclosed herein, the processes described above with reference to the flowcharts may be implemented as computer software programs. For example, embodiments disclosed herein include a computer program product including a computer program embodied on a computer-readable medium, the computer program containing program code for executing the methods illustrated in the flowcharts. In such an embodiment, the computer program can be downloaded and installed from a network via a communication device, or installed from storage device 1003 or ROM 1002. When executed by processing device 1001, the computer program performs the aforementioned functions defined in the method of the embodiment disclosed herein.

The electronic device provided herein, employing the method for processing the audio signal of the aforementioned embodiment, can improve echo cancellation and conserve computing resources required for echo cancellation. Compared to the related art, the electronic device provided herein has the same beneficial effects as the method for processing the audio signal of the aforementioned embodiment, and other technical features of the electronic device are the same as those disclosed in the method of the aforementioned embodiment, and are not further described here.

It should be understood that the various components disclosed herein can be implemented configuring hardware, software, firmware, or a combination thereof. Specific features, structures, materials, or characteristics described in the aforementioned embodiments may be combined in any suitable manner in any one or more embodiments or examples.

The foregoing description is merely a specific embodiment of the present application, but the protection scope of the present application is not limited thereto. Any modifications or substitutions that can be readily conceived by those skilled in the art within the technical scope disclosed herein are intended to be covered by the protection scope of the present application. Therefore, the protection scope of the present application shall be determined by the protection scope of the claims.

The present application provides a computer-readable storage medium having computer-readable program instructions (i.e., a computer program) stored thereon. The computer-readable program instructions are used to execute the method for processing the audio signal described in the above-described embodiment.

The computer-readable storage medium provided in the present application may be, for example, a USB flash drive, but is not limited to, an electrical, magnetic, optical, electromagnetic, infrared, or semiconductor system, system, or device, or any combination thereof. More specific examples of computer-readable storage media may include, but are not limited to: an electrical connection having one or more wires, a portable computer disk, a hard disk, random access memory (RAM), read-only memory (ROM), erasable programmable read-only memory (EPROM or flash memory), optical fiber, a portable compact disk read-only memory (CD-ROM), an optical storage device, a magnetic storage device, or any suitable combination thereof. In this embodiment, the computer-readable storage medium may be any tangible medium containing or storing a program that can be used by or in conjunction with an instruction execution system, system, or device. The program code contained on a computer-readable storage medium can be transmitted via any appropriate medium, including but not limited to wires, optical cables, radio frequency (RF), etc., or any suitable combination thereof.

The computer-readable storage medium may be contained within an electronic device, or may exist independently and not incorporated into the electronic device.

The computer-readable storage medium carries one or more programs. When executed by the electronic device, the one or more programs cause the electronic device to: obtain a current far-end signal and a microphone signal; the microphone signal includes a near-end signal and an echo signal generated by a speaker playing the far-end signal; perform linear echo cancellation processing on the microphone signal to obtain a linear filtered signal; input the linear filtered signal and the far-end signal into a pre-trained residual echo cancellation DNN model to output a gain signal corresponding to the near-end signal; and determine a target audio signal to be output to the far-end based on the gain signal and the linear filtered signal.

Computer program code for performing the operations of the present application can be written in one or more programming languages, or a combination thereof, including object-oriented programming languages, such as Java, Smalltalk, and C++, as well as conventional procedural programming languages, such as C or similar programming languages. The program code can execute entirely on the user's computer, partially on the user's computer, as a stand-alone software package, partially on the user's computer and partially on a remote computer, or entirely on a remote computer or server. In the case of a remote computer, the remote computer can be connected to the user's computer via any type of network, including a local area network (LAN) or a wide area network (WAN), or can be connected to an external computer (e.g., configuring an Internet service provider via the Internet).

The flowcharts and block diagrams in the accompanying drawings illustrate possible implementations of the architecture, functionality, and operations of the systems, methods, and computer program products according to various embodiments of the present application. In this regard, each block in the flowchart or block diagram may represent a module, program segment, or portion of code, which contains one or more executable instructions for implementing the specified logical function. It should also be noted that in some alternative implementations, the functions labeled in the blocks may occur in a different order than that labeled in the accompanying figures. For example, two blocks shown consecutively may actually be executed substantially in parallel, or they may be executed in the opposite order, depending on the functions involved. It should also be noted that each block in the block diagrams and/or flowcharts, as well as combinations of blocks in the block diagrams and/or flowcharts, may be implemented configuring a dedicated hardware-based system that performs the specified functions or operations, or may be implemented configuring a combination of dedicated hardware and computer instructions.

The modules described in the embodiments of the present application may be implemented in software or hardware. The names of the modules do not, in some cases, limit the meaning of the modules themselves.

The computer-readable storage medium provided in the present application is a computer-readable storage medium that stores computer-readable program instructions (i.e., a computer program) for executing the aforementioned method for processing the audio signal, which can improve echo cancellation performance and conserve computing resources required for echo cancellation. Compared to the related art, the computer-readable storage medium provided in the present application has the same beneficial effects as the method for processing the audio signal provided in the aforementioned embodiments and will not be further elaborated here.

Embodiments of the present application provide a computer program product, including a computer program. When executed by a processor, the computer program implements the steps of the method for processing the audio signal described above.

The computer program product provided by the present application can improve echo cancellation performance and save computing resources required for echo cancellation. Compared with the related art, the beneficial effects of the computer program product provided by the present embodiment are similar to those of the method for processing the audio signal provided by the above embodiment, and are not further elaborated here.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. A method for processing an audio signal, comprising:
obtaining a current far-end signal and a current microphone signal, wherein the microphone signal comprises a near-end signal and an echo signal generated by a speaker playing the far-end signal;
performing linear echo cancellation processing on the microphone signal to obtain a linear filtered signal;
inputting the linear filtered signal and the far-end signal into a pre-trained residual echo cancellation deep neural network (DNN) model to output a gain signal corresponding to the near-end signal; and
determining a target audio signal to be output to a far-end for playback based on the gain signal and the linear filtered signal.

2. The method for processing the audio signal according to claim 1, further comprising:
obtaining multiple groups of audio sample data, wherein each group of audio sample data comprises a near-end signal sample and a far-end signal sample;
generating a microphone signal sample corresponding to each group of audio sample data based on the near-end signal sample and the far-end signal sample corresponding to each group of audio sample data;
determining a linear filtered signal sample corresponding to each group of audio sample data based on the microphone signal sample corresponding to each group of audio sample data, wherein the linear filtered signal sample is an audio signal sample obtained by performing linear echo cancellation processing on the microphone signal sample; and
determining training samples based on the far-end signal sample, the linear filtered signal sample, and the microphone signal sample corresponding to each group of audio sample data, and training a deep neural network based on the training samples to obtain a trained residual echo cancellation DNN model, wherein each group of audio sample data corresponds to one training sample.

3. The method for processing the audio signal according to claim 2, wherein the generating the microphone signal sample corresponding to each group of audio sample data based on the near-end signal sample and the far-end signal sample corresponding to each group of audio sample data comprises:
performing audio equalization reverberation processing and audio delay processing on the far-end signal sample corresponding to each group of audio sample data to obtain an analog echo signal sample corresponding to each group of audio sample data; and
superimposing the analog echo signal sample corresponding to each group of audio sample data with the near-end signal sample corresponding to the same group of audio sample data to obtain the microphone signal sample corresponding to each group of audio sample data.

4. The method for processing the audio signal according to claim 2, wherein the training sample comprises a learning sample and a sample label associated with the learning sample;
the determining training samples based on the far-end signal sample, the linear filtered signal sample, and the microphone signal sample corresponding to each group of audio sample data comprises:
determining each learning sample of a deep neural network model based on the far-end signal sample and the linear filtered signal sample in each group of audio sample data; and
determining a sample label associated with each learning sample based on the linear filtered signal sample and the near-end signal sample in each group of audio sample data.

5. The method for processing the audio signal according to claim 4, wherein the determining each learning sample of the deep neural network model based on the far-end signal sample and the linear filtered signal sample in each group of audio sample data comprises:
performing Fourier transform on the far-end signal sample and linear filtered signal sample in each group of audio sample data to obtain the far-end signal sample and the linear filtered signal sample after Fourier transform;
concatenating the far-end signal sample and the linear filtered signal sample in the same group of audio sample data after Fourier transform to obtain an audio vector sample corresponding to each group of audio sample data; and
configuring the audio vector sample corresponding to each group of audio sample data as each learning sample for the deep neural network model, wherein one audio vector sample corresponds to one learning sample.

6. The method for processing the audio signal according to claim 5, wherein the determining the sample label associated with each learning sample based on the linear filtered signal sample and the near-end signal sample in each group of audio sample data comprises:
performing Fourier transform on the linear filtered signal sample and the near-end signal sample in each group of audio sample data to obtain the linear filtered signal sample and the near-end signal sample after Fourier transform;
dividing the linear filtered signal sample and the near-end signal sample in the same group of audio sample data after Fourier transform to obtain a gain signal sample corresponding to each group of audio sample data; and
configuring the gain signal sample corresponding to each group of audio sample data as the sample label associated with each learning sample, wherein one gain signal sample corresponds to one sample label, and one learning sample is associated with one sample label; the sample label associated with the learning sample is the gain signal sample corresponding to the same group of audio sample data.

7. The method for processing the audio signal according to claim 6, wherein the determining the target audio signal to be output to the far-end based on the gain signal and the linear filtered signal comprises:
multiplying the gain signal and the linear filtered signal to obtain a product audio vector; and
configuring the product audio vector as the target audio signal to be output to the far-end for playback.

8. The method for processing the audio signal according to claim 1, wherein the obtaining the current far-end signal and the current microphone signal comprises:
dynamically collecting a far-end audio time domain signal and a microphone audio time domain signal generated during a call, wherein the microphone signal comprises a near-end audio time domain signal and an echo audio time domain signal generated by a speaker playing the far-end audio time domain signal;
performing Fourier transform on the far-end audio time domain signal and the microphone audio time domain signal, respectively, to obtain a far-end audio frequency domain signal and a microphone audio frequency domain signal; and
configuring the far-end audio frequency domain signal as the current far-end signal, and configuring the microphone audio frequency domain signal as the current microphone signal.

9. An electronic device, comprising:
at least one processor; and
a memory communicatively connected to the at least one processor;
wherein the memory stores instructions executable by the at least one processor, and the instructions are executed by the at least one processor to enable the at least one processor to implement the steps of the method for processing the audio signal according to claim 1.

10. A computer-readable storage medium, wherein the computer-readable storage medium stores a program for implementing a method for processing an audio signal, and the program is executed by a processor to implement the steps of the method for processing the audio signal according to claim 1.
